(19) United States
(12) Patent Application Publication
(10) Pub. No.: US 2020/0146039 A1
(43) Pub. Date: May 7, 2020

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Xiaohang Chen, Beijing (CN); Qun Zhao, Beijing (CN); Xiaolin Hou, Beijing (CN); Huiling Jiang, Beijing (CN)

(73) Assignee: NTT DOCOMO, INC., Tokyo (JP)

(21) Appl. No.: 16/496,157

(22) PCT Filed: Mar. 23, 2017
(86) PCT No.: PCT/JP2017/011894

§ 371 Date: Sep. 20, 2019

(51) Int. Cl. H04W 72/12; H04W 74/08; H04L 1/18

(52) U.S. Cl. CPC H04W 72/1284; H04L 1/1812; H04W 74/08

(57) ABSTRACT

In order to communicate properly when using contention-based UL transmission that adopts repetition transmission, according to one aspect of the present invention, a terminal has a transmission section that transmits UL data without a UL transmission command from a radio base station, and a control section that controls repetition transmission of the UL data by using a transport block (TB), and, when the UL data is transmitted using a plurality of TBs, the control section at least time-division-multiplexes, frequency-division-multiplexes or code-division-multiplexes each TB.

### TECHNICAL FIELD

The present invention relates to a terminal and a radio communication method in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower delays and so on (see non-patent literature 1). In addition, successor systems of LTE are also under study for the purpose of achieving further broadbandization and increased speed beyond LTE (referred to as, for example, “LTE-A (LTE-Advanced),” “FRA (Future Radio Access),” “4G,” “5G,” “5G+ (plus),” “NR (New RAT),” “LTE Rel. 14,” “LTE Rel. 15 (or later versions),” and so on).

In existing LTE systems (for example, LTE Rel. 8 to 13), downlink (DL) and/or uplink (UL) communication are performed using 1-ms subframes (also referred to as “transmission time intervals (TTIs)” and so on). These subframes are the time unit for transmitting 1 channel-encoded data packet, and serve as the unit of processing in, for example, scheduling, link adaptation, retransmission control (HARQ (Hybrid Automatic Repeat reQuest)) and so on.

A radio base station controls the allocation (scheduling) of data for a terminal, and reports the schedule of data to the terminal using downlink control information (DCI). The terminal controls receipt of DL data and transmission of uplink data based on the downlink control information. For example, in existing LTE systems, when a terminal receives downlink control information that commands UL transmission (for example, a UL grant), after a predetermined period (for example, 4 ms later), the terminal transmits uplink data in a predetermined subframe.

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Future radio communication systems (for example, LTE Rel. 14, 15 or later versions, 5G, NR, etc.) might control data scheduling based on different configurations than existing LTE systems (for example, LTE Rel. 13 or earlier versions). For example, in order to provide communication services that require low latency and high reliability (for example, URLLC (Ultra Reliable and Low Latency Communications)), research is underway to reduce communication latency (latency reduction).

To be more specific, in order to reduce the latency time before UL data transmission starts, study is in progress to perform communication by permitting collisions of UL transmissions among a plurality of terminals. For example, study is underway to allow terminals to transmit UL data without UL grants from radio base stations (also referred to as “UL grant-free UL transmission,” “UL grant-less UL transmission,” “contention-based UL transmission,” “UL grant-less and contention-based UL transmission,” and so on).

However, what kind of control is executed when terminals adopt contention-based UL transmission and transmit UL data is not decided yet, and it is difficult to apply methods for existing LTE systems that are premised on UL grant-based UL transmission. In addition, although research is underway to apply repetition transmission to contention-based UL transmission, the problem lies in how to control this repetition transmission.

The present invention has been made in the view of the above, and it is therefore an object of the present invention to provide a terminal and a radio communication method, whereby communication can be performed properly when using contention-based UL transmission that adopts repetition transmission.

### Solution to Problem

According to one aspect of the present invention, a terminal has a transmission section that transmits UL data without a UL transmission command from a radio base station, and a control section that controls repetition transmission of the UL data by using a transport block (TB), and, when the UL data is transmitted using a plurality of TBs, the control section at least time-division-multiplexes, frequency-division-multiplexes or code-division-multiplexes each TB.

### Advantageous Effects of Invention

According to the present invention, communication can be performed properly when using contention-based UL transmission that adopts repetition transmission.

### BRIEF DESCRIPTION OF DRAWINGS

FIG. 1A is a diagram to explain UL grant-based transmission, and FIG. 1B is a diagram to explain UL grant-free transmission;

FIG. 2A and FIG. 2B provide diagrams to show examples of transmitting UL data by using a plurality of TBs;

FIG. 2A is a diagram to show a transmission method, and FIG. 2B is a diagram to show a packet;

FIG. 3A and FIG. 3B provide diagrams to show examples in which new data is produced in the middle of UL grant-free transmission;

FIG. 3A is a diagram to show a transmission method, and FIG. 3B is a diagram to show a packet;

FIG. 4A and FIG. 4B provide diagrams to show examples of the UL data transmission method according to the first example of the present invention;

FIG. 4A is a diagram to show a packet that is stored in a UE buffer, and FIG. 4B is a diagram to show the transmission method according to the first example;

FIG. 5 is a diagram to show an example of the UL data transmission method according to a second example of the present invention;

FIG. 6 is a diagram to show an example of the UL data transmission method according to the first option in a third example of the present invention;

FIG. 7 is a diagram to explain problems in the event repetition transmission is performed using a plurality of TBs;

FIG. 8 is a diagram to show an example in which TBs and RS information are associated;

FIG. 9 is a diagram to show another example in which TBs and RS information are associated;

FIG. 10 is a diagram to explain an example of the reporting method according to a fifth example of the present invention;

FIG. 11 is a diagram to show the relationship between information signaling and URLLC packet transmission;

FIG. 12 is a diagram to show the relationship between information signaling and URLLC packet transmission;

FIG. 13 is a diagram to show an exemplary schematic structure of a radio communication system according to one embodiment of the present invention;

FIG. 14 is a diagram to show an exemplary overall structure of a radio base station according to one embodiment of the present invention;

FIG. 15 is a diagram to show an exemplary functional structure of a radio base station according to one embodiment of the present invention;

FIG. 16 is a diagram to show an exemplary overall structure of a terminal according to one embodiment of the present invention;

FIG. 17 is a diagram to show an exemplary functional structure of a terminal according to one embodiment of the present invention; and

FIG. 18 is a diagram to show an exemplary hardware structure of a radio base station and a terminal according to one embodiment of the present invention.

### DESCRIPTION OF EMBODIMENTS

Future radio communication systems are expected to accommodate various services such as high-speed and large-capacity communication (eMBB (enhanced Mobile Broad Band)), massive access (mMTC (massive MTC)) from devices (terminals) for inter-device communication (M2M (Machine-to-Machine)) such as IoT (Internet of Things) and MTC (Machine Type Communication), low-latency and high-reliability communication (URLLC (Ultra-Reliable and Low Latency Communication)) and so on, using a single framework.

To fulfill the demand for URLLC, it may be necessary, for example, to keep the latency on the U-plane 0.5 ms or less, and transmit information of a predetermined payload size with a reliability of BLER (Block Error Rate)=10⁻⁵, in 0.5 ms or 1 ms.

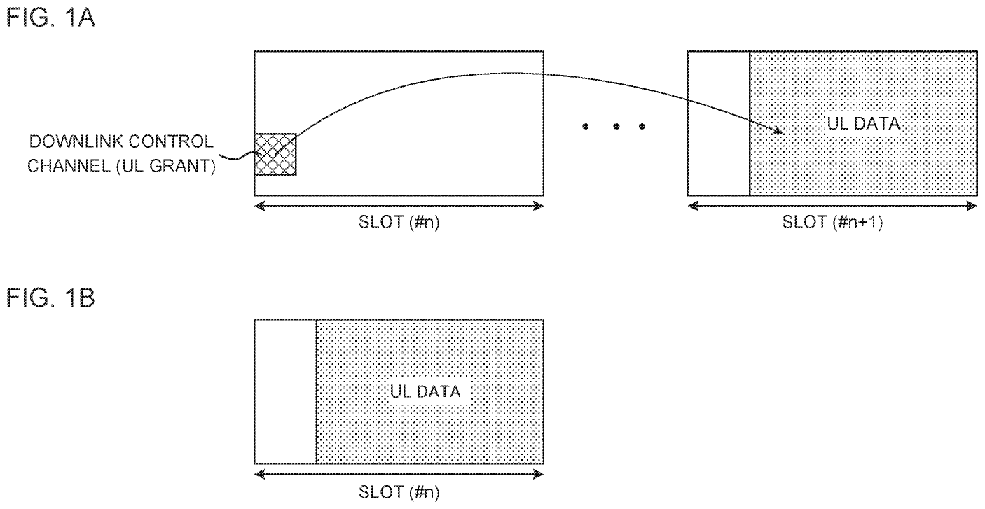

To fulfill the demand for URLLC, UL grant-based transmission, in which UL data is transmitted based on UL grants, is not enough, and it is necessary to employ UL grant-free transmission, in which UL data is transmitted without UL grants. Here, UL grant-based transmission and UL grant-free transmission will be explained. FIG. 1A is a diagram to explain UL grant-based transmission, and FIG. 1B is a diagram to explain UL grant-free transmission.

In UL grant-based transmission, as shown in FIG. 1A, a radio base station transmits a downlink control channel (UL grant), which commands allocation of UL data (PUSCH), and a terminal (UE (User Equipment)) transmits UL data in accordance with the UL grant. Meanwhile, in UL grant-free transmission, as shown in FIG. 1B, a terminal transmits UL data without receiving UL grants for data scheduling.

Also, regarding UL grant-free transmission, studies are underway to introduce repetition transmission of UL data. When UL data is subject to repetition transmission, the terminal is likely to repeat transmitting the UL data a predetermined number of times (K times), by using transport blocks (TBs) (in units of TBs). For example, the terminal keeps transmitting TBs corresponding to the UL data until downlink control information (UL grant) to command retransmission of the UL data is transmitted, or until the number of times transmission is repeated reaches the above predetermined number.

In this way, when the terminal repeats transmitting UL data a predetermined number of times (K times), the redundancy version (RV) and/or the modulation and coding scheme (MCS) of the TB to be transmitted repeatedly may be the same throughout K times, including the initial transmission, or may be set to different values. Also, frequency hopping may be applied to this repetition transmission.

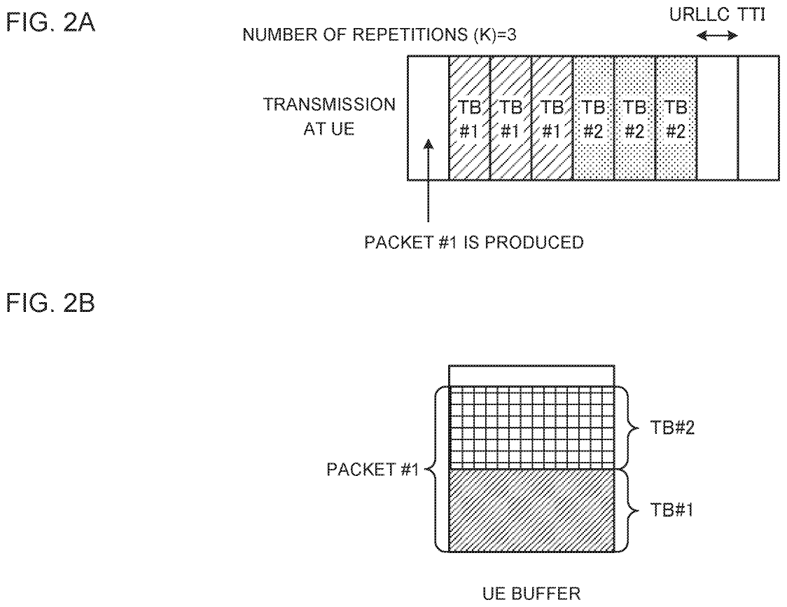

In UL grant-free transmission, when data that cannot be transmitted in 1 TB size is accumulated in a UE buffer, it may be possible to transmit UL data using multiple TBs (for example, TB #1 and TB #2). FIG. 2 provide diagrams to show examples of transmitting UL data by using a plurality of TBs. FIG. 2A is a diagram to show a transmission method, and FIG. 2B is a diagram to show a packet. Referring to FIG. 2B, data that cannot be transmitted in 1 TB size is stored in a UE buffer, and therefore packet 1 is comprised of multiple TBs (TB #1 and TB #2). Referring to FIG. 2A, Provided that the number of repetitions, or K, is 3, when packet #1 is produced, first, TB #1 repeats being transmitted 3 times, and, following this, TB #2 repeats being transmitted 3 times.

In the repetition transmission shown in FIG. 2A, TB #2 is subjected to repetition transmission after the repetition transmission of TB #1 is finished. This is to prevent TB #1 and TB #2 from being erroneously combined upon demodulation on the radio base station side. As described above, when a TB that corresponds to new data (for example, TB #2) is there to be transmitted, it is necessary to wait until the transmission and receipt of the TBs to be transmitted first (for example, TB #1) are finished, and therefore the latency grows.

Here, when transmitting UL data for every TB, a HARQ (Hybrid Automatic Repeat reQuest) process is assigned. Here, HARQ processes are processing units in retransmission control, and every HARQ process is identified by a HARQ process number (HPN). The terminal is configured with one or more HARQ processes. In a HARQ process of a given number, the same data keeps being retransmitted until an ACK is received.

If the HARQ process is applied to repetition transmission based on UL grant free as described above, As shown in FIG. 2B, when data that cannot be transmitted in 1 TB size is stored in the UE buffer, if only 1 HARQ process is used, it would be acceptable to transmit large sized TBs using higher order modulation schemes. As a result, a high SINR (Signal to Interference plus Noise Ratio) is required for reception, and the reliability of communication is likely to be degraded. Meanwhile, when using multiple HARQ processes, the radio base station (gNB) needs to identify each HARQ process. The radio base station also needs to take into account processing delays.

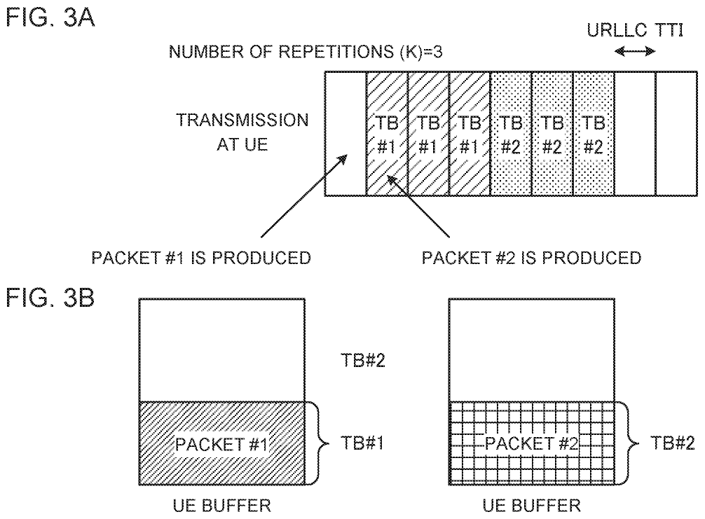

Also, new data (new traffic) may be generated during transmission/reception of data transmitted in UL grant free. FIG. 3 provide diagrams to show examples in which new data is produced in the middle of UL grant-free transmission. FIG. 3A is a diagram to show a transmission method, and FIG. 3B is a diagram to show a packet. Referring to FIG. 3A, while TB #1 corresponding to packet #1 shown in FIG. 3B is being transmitted (in FIG. 3A, at the time of initial transmission of TB #1) new data (packet #2 shown in FIG. 3B) is produced. Referring to FIG. 2A, provided that the number of repetitions, or K, is 3, first, TB #1, which corresponds to packet #1 is transmitted 3 times, in repetition, and then TB #2, which corresponds to packet #2, is transmitted 3 times in repetition.

In the repetition transmission shown in FIG. 3A, TB #2 is subjected to repetition transmission after the repetition transmission of TB #1 is finished. This is to prevent TB #1 and TB #2 from being erroneously combined in demodulation at the radio base station side. As described above, when a TB that corresponds to new data (for example, TB #2) is there to be transmitted, it is necessary to wait until the transmission and receipt of the TBs to be transmitted first (for example, TB #1) are finished, and therefore the latency grows.

So, the present inventors have focused on the fact that, when repetition transmission is applied to UL grant-free transmission, transmission latency is produced because the transmission of preceding TBs has to be finished first before subsequent TBs are transmitted, and come up with the idea of controlling each TB's transmission so as to prevent the growth of latency. That is, one example of the present invention is designed so that, in order to communicate properly when contention-based UL transmission to adopt repetition transmission is used, when UL data is transmitted without UL transmission commands from a radio base station, using repetition transmission, a number of TBs are at least time-division-multiplexed, frequency-division-multiplexed or code-division-multiplexed.

Now, embodiments of the present invention will be described in detail below with reference to the accompanying drawings. Note that the radio communication methods according to the herein-contained embodiments may be used individually or may be used in combination. Also, in the following description, UL data transmission is controlled using TBs (TB units), but the present embodiment is not limited to this. For example, even when UL transmission is controlled using code blocks (CBs) (in units of CBs), the present invention can be applied similarly.

### FIRST EXAMPLE

In this example, when a packet contains multiple TBs, multiple TBs are frequency-division-multiplexed (FDM) and/or code-division-multiplexed (CDM).

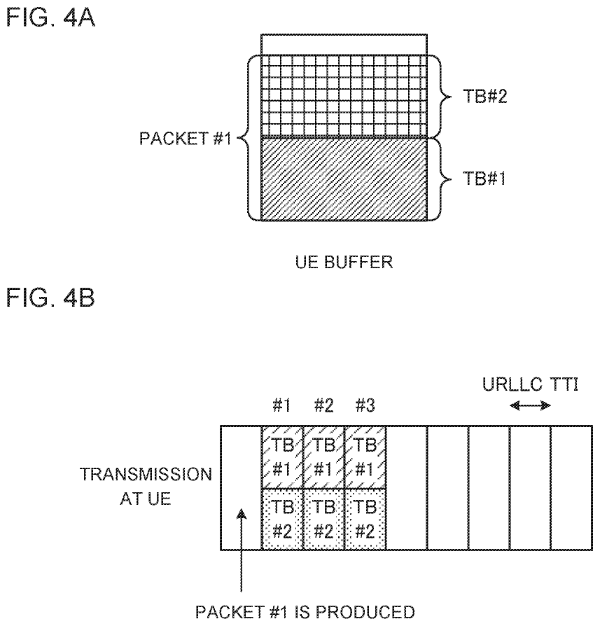

FIG. 4 is a diagram to show an example of the UL data transmission method according to the first aspect. FIG. 4A is a diagram to show a packets that is stored in a UE buffer, and FIG. 4B is a diagram to show the transmission method according to the first example.

In the present example, for example, as shown in FIG. 4A, when data that cannot be transmitted in 1 TB size is stored in a UE buffer and UL data is transmitted using multiple TBs (for example, TB #1 and TB #2), as shown in FIG. 4B, TB #1 and TB #2 are frequency-division-multiplexed before each TB is transmitted repeatedly. That is, for example, TB #2 is frequency-division-multiplexed with TB #1 that is transmitted repeatedly. Note that information about the frequencies to allocate to TB #1 and TB #2 is reported from the radio base station by way of higher layer signaling and the like.

Also, with the present example, when a number of TBs (for example, TB #1 and TB #2) are code-division-multiplexed, TB #1 and TB #2 are both applied different codes. That is, referring to FIG. 4B, TB #1 that is transmitted in TTI #1 to TTI #3 is multiplied by the first code, and TB #2 that is transmitted in TTI #1 to TTI #3 is multiplied by a second code. Note that information about the codes to multiply TB #1 and TB #2 by is reported from the radio base station by way of higher layer signaling and the like.

In this case, TB #1 and TB #2 are transmitted in different channels within UL grant-free resources. Also, TB #1 and TB #2 are associated with respective reference signals, so that TB #1 and TB #2 can be demodulated individually. Also, the start of transmission of TB #2 may not be the same as the start of transmission of TB #1, or may be the same as the start of transmission of TB #1. Furthermore, the number of repetitions of TB #2, or K′, may be the same as or different from the number of repetitions of TB #1, or K. Also, if HARQ-ACK is supported for UL grant-free data, the UE transmits HARQ-ACK in response to each of TB #1 and TB #2.

In this way, when multiple TBs are transmitted using repetition transmission, multiple TBs are frequency-division-multiplexed before each TB is transmitted repeatedly, so that it is possible to prevent latency form being produced in particular TBs.

### SECOND EXAMPLE

With this example, when a packet contains multiple TBs, multiple TBs are time-division-multiplexed (TDM)).

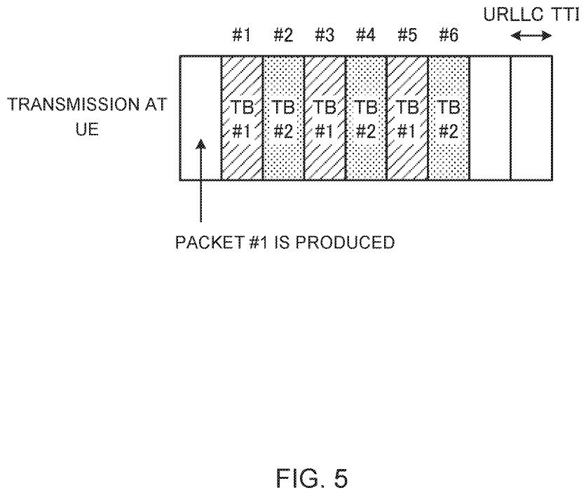

FIG. 5 is a diagram to show an example of the UL data transmission method according to a second example of the present invention. In the present example, a plurality of TBs are allocated by dividing the time domain. Note that the time domain information to allocate to TB #1 and TB #2 is reported from the radio base station by way of higher layer signaling and the like. In FIG. 5, TB #1 is allocated to TTIs #1, #3 and #5, and TB #2 is allocated to TTIs #2, #4 and #6.

According to the present example, when TB #2 is not present between repeated transmissions of TB #1, the terminal keeps transmitting TB #1. On the other hand, when TB #2 is present between repeated transmissions of TB #1, the terminal transmits TB #1 and TB #2 by using time division multiplexing. Note that, although FIG. 5 shows a time division pattern, in which TB #1 and TB #2 are transmitted alternately, the present example is not limited to this, and another pattern of time-division-multiplexing may be used.

### THIRD EXAMPLE

The present example assumes that there are multiple TBs. With the present example, there are 3 options. First, in the first option, repetition transmission of a TB corresponding to UL data is suspended, and, after a TB corresponding to initial transmission of new data is transmitted, the repetition transmission of the already-transmitted TB, corresponding to UL data, is resumed. In this way, according to the first option, during repetition transmission based on UL grant-free transmission, resource for a TB (TB #1) corresponding to UL data is made empty, and a TB corresponding to new data (TB #2) is transmitted using this resource.

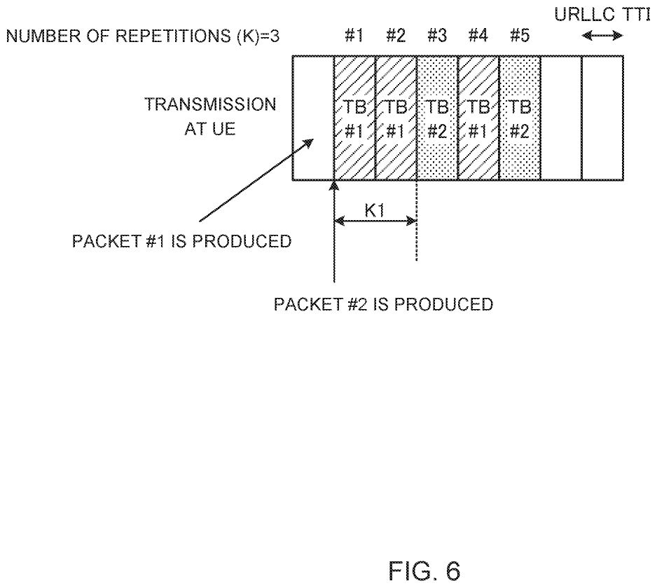

FIG. 6 is a diagram to show an example of the UL data transmission method according to the first option in a third example of the present invention. As shown in FIG. 6, when packet #1 and packet #2 are produced, first, repetition transmission (the number of repetitions K=3) of a TB (TB #1) corresponding to UL data is suspended (suspended in TTI #1 and TTI #2). Then, after K1 TTIs are over, a TB corresponding to initial transmission of new data (TB #2) is transmitted. Then, the repetition transmission of the TB corresponding to UL data (TB #1) is resumed (TTI #4). Following this, the TB corresponding to new data (TB #2) is transmitted in repetition transmission. Note that K1 (K1≥1) is configured by higher layer based on the requirement for latency in communication.

In the UL data transmission method according to the second option of the third example, multiple TBs are frequency-division-multiplexed or code-division-multiplexed. This is the same as the UL data transmission method according to the first example shown in FIG. 4B.

In the UL data transmission method according to the second option of the third example, a scheduling request for new data is reported. In this method, a terminal reports a scheduling request for new data to a radio base station via a control channel, and the radio base station transmits a UL grant for scheduling new data to the terminal.

### FOURTH EXAMPLE

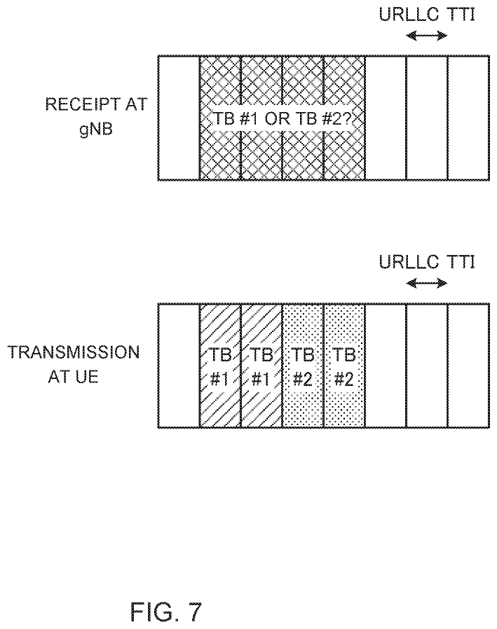

As shown in FIG. 7, when a terminal (UE) transmits multiple TBs (TB #1 and TB #2) to a radio base station (gNB), if the radio base station fails to receive UL data (for example, the decoding process), the radio base station is unable to determine whether TB #1 has been transmitted or TB #2 has been transmitted. As a result of this, even if the radio base station tries to schedule retransmission by using a UL grant, unless the radio base station identifies which data the radio base station has failed to detect, there is a danger that the radio base station cannot even start controlling retransmission.

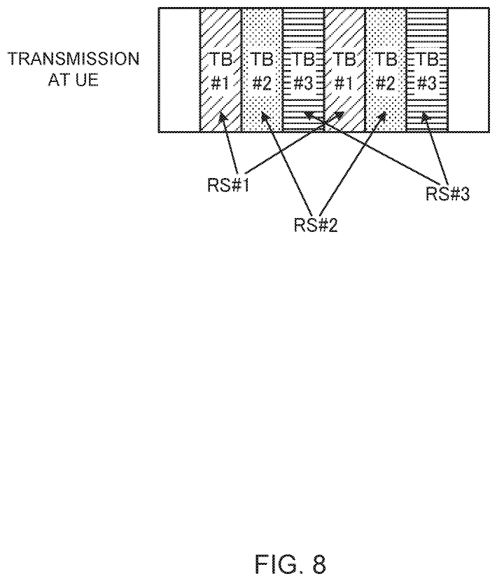

In order to solve the above problem, according to the present example, when each TB is transmitted, information to identify each TB is transmitted from the terminal to the radio base station. The information identifying each TB may be reference signal information, including, for example, an RS sequence, an RS index, an RS pattern, an RSID and the like. For example, as shown in FIG. 8, RS #1 is allocated to TB #1, RS #2 is allocated to TB #2, and RS #3 is allocated to TB #3. This allows the radio base station to judge which TB has been transmitted, by detecting RS information.

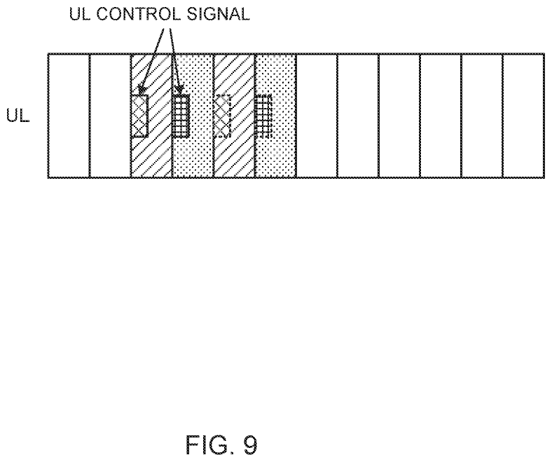

Also, as shown in FIG. 9, information about the allocation of TBs and RS information may be transmitted from the terminal to the radio base station, by using a UL control signal, in UL grant-free transmission. Also, the UL control signals may include HARQ process/index information. Note that, in the event repetition transmission is used in UL grant-free transmission, the UL control signal may be transmitted only in the initial transmission of each TB, and may not be transmitted in subsequent transmissions.

In the present example, HARQ processes are associated with RS information (for example, RS series or RS code), scrambling patterns or UE identification information, so that the radio base station can identify which TB has been transmitted and which HARQ process is used, by detecting the RS information, scrambling pattern or UE identification information.

### FIFTH EXAMPLE

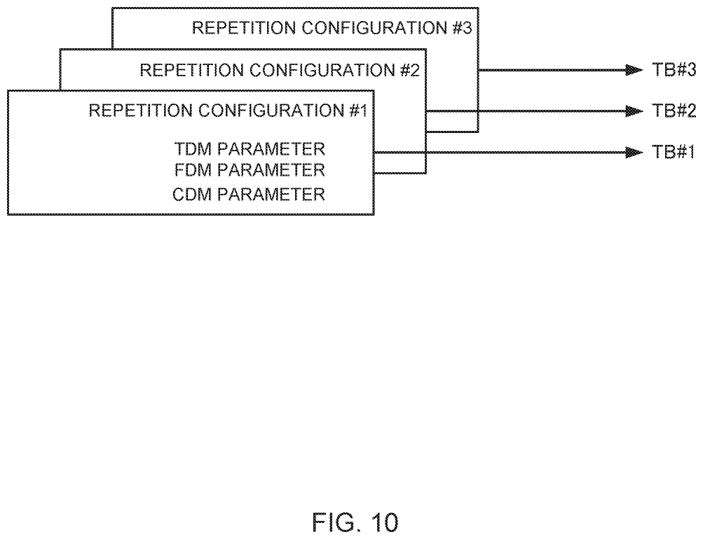

According to this example, a terminal receives at least one of information about the number of TBs used to transmit UL data, information about the configuration of repetition transmission of TBs, and information about the TBs that are configured. These pieces of information, as shown in FIG. 10, are configured for each TB (TB #1, TB #2 and TB #3). The information about the configuration of repetition transmission of TBs includes TDM parameters, FDM parameters, CDM parameters and the like. These pieces of information, for example, may be reported semi-statically by way of RRC signaling, or may be reported by way of dynamic DL signaling.

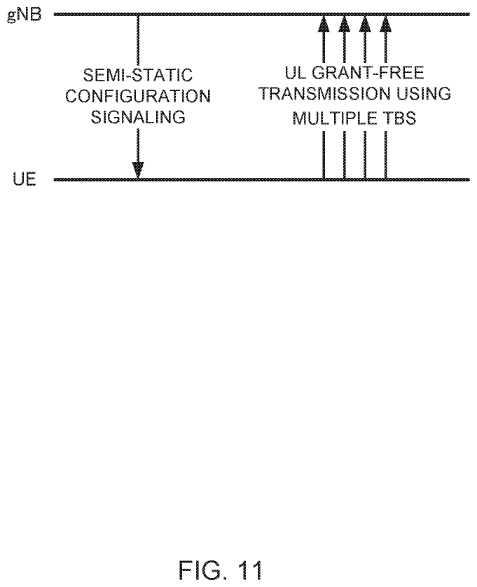

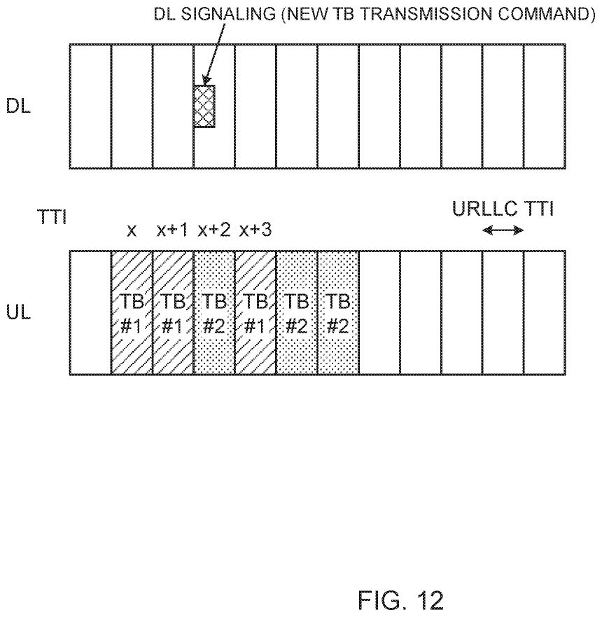

FIG. 11 and FIG. 12 are diagrams to show the relationship between information signaling and URLLC packet transmission. FIG. 11 shows a case of transmitting the above information by way of semi-static signaling, and FIG. 12 shows a case of transmitting the above information by way of DL-dynamic signaling.

As shown in FIG. 11, a radio base station (gNB) transmits configuration information for a plurality of TB transmissions to a terminal (UE) semi-statically, by using, for example, RRC signaling. After receiving the configuration information, the terminal performs UL grant-free transmission for the radio base station. By this means, the overhead of signaling can be reduced.

As shown in FIG. 12, a radio base station (gNB) transmits DL signaling to carry a new TB transmission command to a terminal (UE). This new TB transmission command, for example, commands transmission of TB #2 in TTIx+2, suspension of repetition of TB #1, and the like. By this means, the terminal does not transmit TB #1 in TTIx+2, and transmits TB #2. Note that the TB transmission command is not limited to the command shown in FIG. 12, and can be changed as appropriate. In this case, transmission command can be quickly reflected on UL transmission.

(Radio Communication System)

Now, the structure of the radio communication system according to one embodiment of the present invention will be described below. In this radio communication system, communication is performed using one of the radio communication methods according to the herein-contained embodiments of the present invention, or a combination of these.

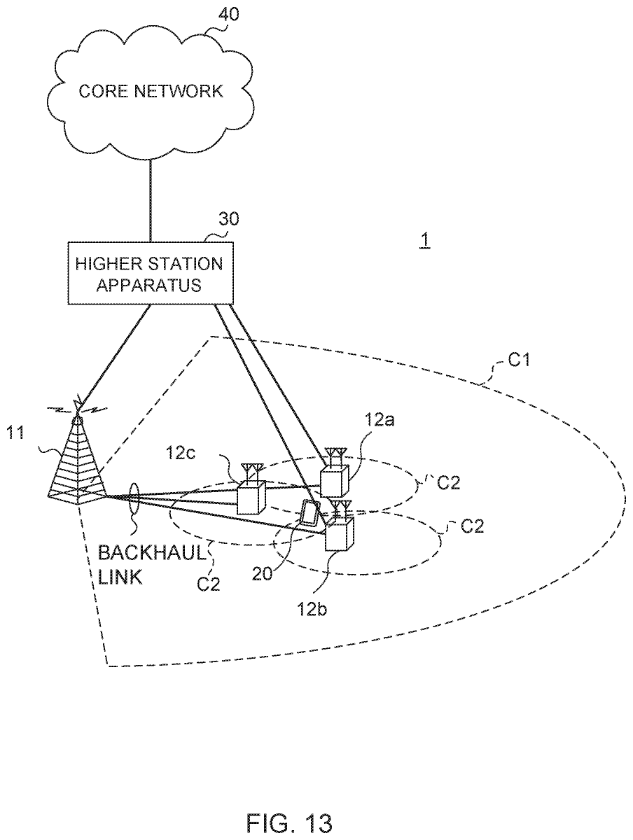

FIG. 13 is a diagram to show an exemplary schematic structure of a radio communication system according to one embodiment of the present invention. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes 1 unit.

In the radio communication system 1, a terminal transmits UL data and a reference signal to a radio base station without a UL grant. For the reference signal in this case, the terminal uses a reference signal that can identify the terminal, and transmits UL data and the reference signal by using predetermined resources that are configured in advance.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th Generation mobile communication system),” “5G (5th Generation mobile communication system),” “FRA (Future Radio Access),” “New-RAT (Radio Access Technology),” “NR (New RAdio),” and so on, or may be seen as a system to implement these.

The radio communication system 1 includes a radio base station 11 that forms a macro cell C1, with a relatively wide coverage, and radio base stations 12a to 12c that are placed within the macro cell C1 and that form small cells C2, which are narrower than the macro cell C1. Also, terminals 20 are placed in the macro cell C1 and in each small cell C2. The arrangements of cells and terminals 20 are not limited to those illustrated in the drawings.

The terminals 20 can connect with both the radio base station 11 and the radio base stations 12. The terminals 20 may use the macro cell C1 and the small cells C2 at the same time by means of CA or DC. Furthermore, the terminals 20 may apply CA or DC using a plurality of cells (CCs) (for example, 5 or fewer CCs or 6 or more CCs).

Between the terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between 2 radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “gNB,” a “transmitting/receiving point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter the radio base stations 11 and 12 will be collectively referred to as “radio base stations 10,” unless specified otherwise.

The terminals 20 are terminals to support various communication schemes such as LTE, LTE-A and so on, and may be either mobile communication terminals (mobile stations) or stationary communication terminals (fixed stations).

In the radio communication system 1, as radio access schemes, OFDMA (Orthogonal Frequency Division Multiple Access) is applied to the downlink and SC-FDMA (Single-Carrier Frequency Division Multiple Access) is applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to the combinations of these, and other radio access schemes may be used as well.

The radio communication system 1 may be structured so that different numerologies are applied within cells and/or between cells. Note that, a numerology refers to, for example, a communication parameter (for example, subcarrier spacing, bandwidth, etc.) that is used to transmit and receive a certain signal.

In the radio communication system 1, a downlink shared channel (PDSCH (Physical Downlink Shared CHannel)), which is used by each terminal 20 on a shared basis, a broadcast channel (PBCH (Physical Broadcast CHannel)), downlink L1/L2 control channels and so on are used as downlink channels. User data, higher layer control information, SIBs (System Information Blocks) and so on are communicated in the PDSCH. Also, the MIB (Master Information Block) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ (Hybrid Automatic Repeat reQuest) delivery acknowledgment information (also referred to as, for example, “retransmission control information,” “HARQ-ACK,” “ACK/NACK,” and so forth) in response to the PUSCH is communicated by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each terminal 20 on a shared basis, an uplink control channel (PUCCH (Physical Uplink Control CHannel)), a random access channel (PRACH (Physical Random Access CHannel)) and so on are used as uplink channels. User data, higher layer control information and so on are communicated by the PUSCH. Also, downlink radio quality information (CQI (Channel Quality Indicator)), delivery acknowledgment information and so on are communicated by the PUCCH. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (SRS (Sounding Reference Signal)), demodulation reference signal (DMRS) and so on are communicated as uplink reference signals. Note that the DMRS may be referred to as a “terminal-specific reference signal (UE-specific Reference Signal).” Also, the reference signals to be communicated are by no means limited to these.

(Radio Base Station)

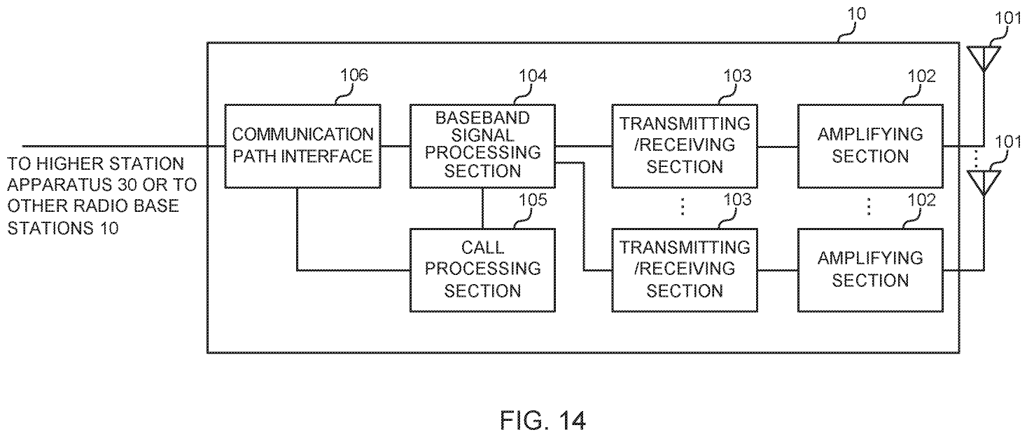

FIG. 14 is a diagram to show an exemplary overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a terminal 20 on the downlink is input from the higher station apparatus 30 to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing of communication channels (such as setting up and releasing communication channels), manages the state of the radio base stations 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

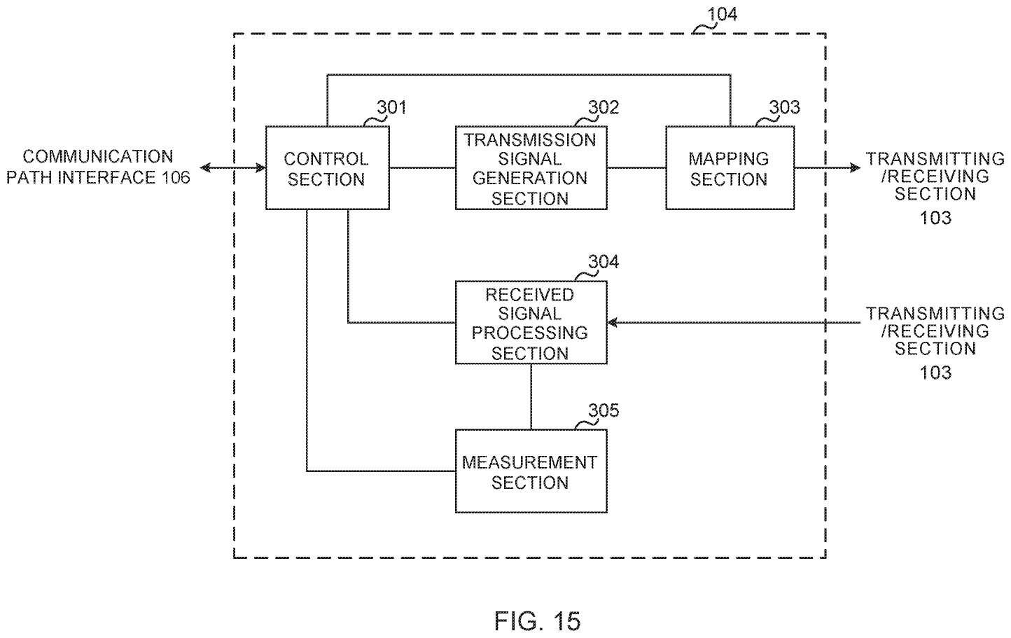

FIG. 15 is a diagram to show an exemplary functional structure of a radio base station according to one embodiment of the present invention. Note that, although this example primarily shows functional blocks that pertain to characteristic parts of the present embodiment, the radio base station 10 has other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301 controls, for example, the generation of signals in the transmission signal generation section 302, the allocation of signals by the mapping section 303 and so on. Furthermore, the control section 301 controls the signal receiving processes in the received signal processing section 304, the measurements of signals in the measurement section 305, and so on.

The control section 301 controls the scheduling (for example, resource allocation) of system information, downlink data signals (for example, signals transmitted in the PDSCH) and downlink control signals (for example, signals communicated in downlink control channels). Also, the control section 301 controls the generation of downlink control signals (for example, delivery acknowledgement information), downlink data signals and so on, based on the results of deciding whether or not retransmission control is necessary for uplink data signals, and so on. Also, the control section 301 controls the scheduling of synchronization signals (for example, PSS (Primary Synchronization Signal)/SSS (Secondary Synchronization Signal)), downlink reference signals (for example, CRS, CSI-RS, DMRS, etc.) and so on.

The transmission signal generation section 302 generates downlink signals (downlink control signals, downlink data signals, downlink reference signals and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink signal allocation information, and UL grants, which report uplink signal allocation information, based on commands from the control section 301. Also, the downlink data signals are subjected to the coding process, the modulation process and so on, by using coding rates and modulation schemes that are selected based on, for example, channel state information (CSI) from each terminal 20.

The mapping section 303 maps the downlink signals generated in the transmission signal generation section 302 to predetermined radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the terminal 20 (uplink control signals, uplink data signals, uplink reference signals, etc.). For the received signal processing section 304, a signal processor, a signal processing circuit or signal processing apparatus that can be described based on general understanding of the technical field to which the present invention pertains can be used.

The received signal processing section 304 outputs the decoded information, acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signal. The measurement section 305 can be constituted by a measurer, a measurement circuit or measurement apparatus that can be described based on general understanding of the technical field to which the present invention pertains.

The measurement section 305 may measure the received power (for example, RSRP (Reference Signal Received Power)), the received quality (for example, RSRQ (Reference Signal Received Quality), SINR (Signal to Interference plus Noise Ratio), etc.), uplink transmission path information (for example, CSI), and so on. The measurement results may be output to the control section 301.

(Terminal)

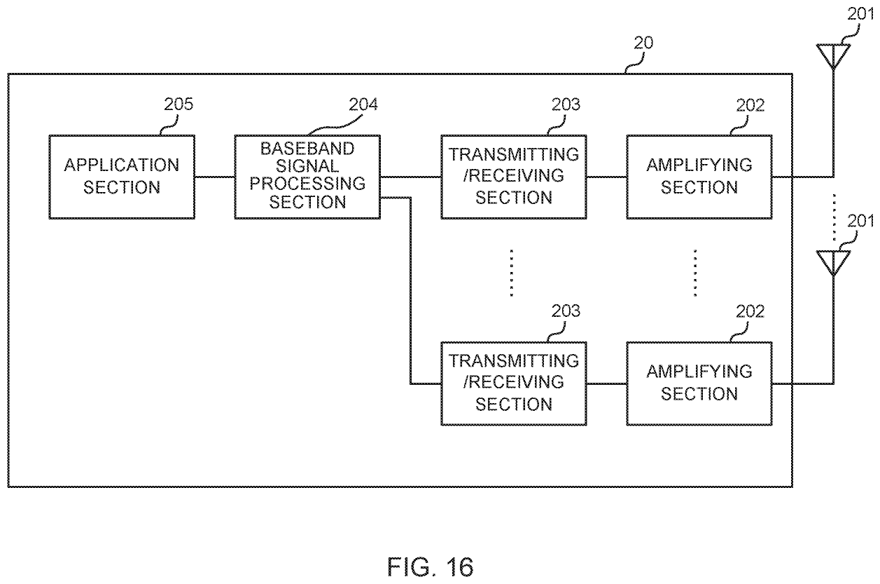

FIG. 16 is a diagram to show an exemplary overall structure of a terminal according to one embodiment of the present invention. A terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203. Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

In addition, the transmitting/receiving sections 203 receive at least one of information about the number of TBs used to transmit UL data, information about the configuration of repetition transmission of TBs, and information about the TBs to be configured (the fourth example and the fifth example). Also, the transmitting/receiving sections 203 transmit information identifying each TB (see FIG. 9 to FIG. 12) when transmitting each TB.

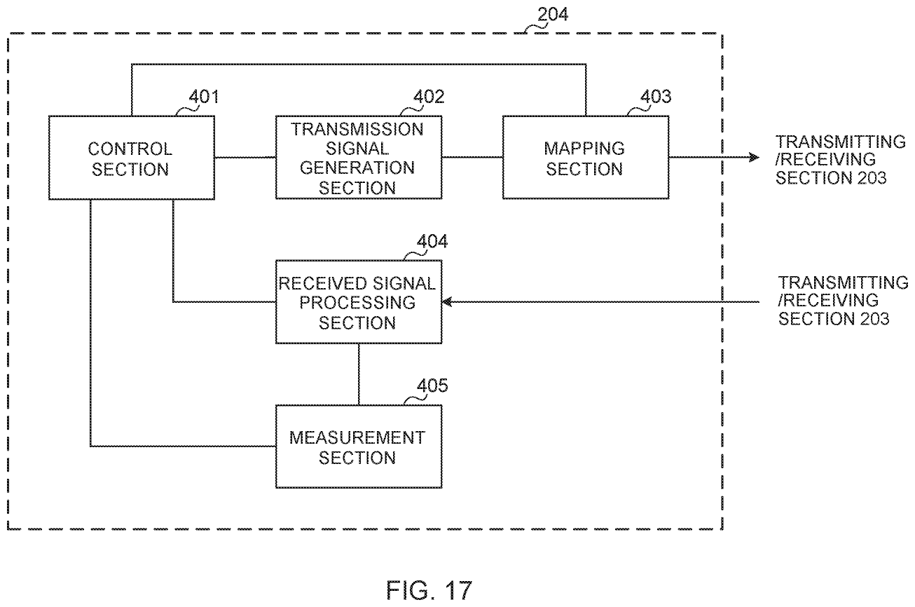

FIG. 17 is a diagram to show an exemplary functional structure of a terminal according to one embodiment of the present invention. Note that, although this example primarily shows functional blocks that pertain to characteristic parts of the present embodiment, the terminal 20 has other functional blocks that are necessary for radio communication as well.

The baseband signal processing section 204 provided in the terminal 20 at least has a control section 401, a transmission signal generation section 402, a mapping section 403, a received signal processing section 404 and a measurement section 405. Note that these configurations have only to be included in the terminal 20, and some or all of these configurations may not be included in the baseband signal processing section 204.

The control section 401 controls the whole of the terminal 20. For the control section 401, a controller, a control circuit or control apparatus that can be described based on general understanding of the technical field to which the present invention pertains can be used.

The control section 401, for example, controls the generation of signals in the transmission signal generation section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (for example, signals transmitted in a downlink control channel) and downlink data signals (for example, signals transmitted in the PDSCH) transmitted from the radio base station 10, via the received signal processing section 404. The control section 401 controls the generation of uplink control signals (for example, delivery acknowledgement information) and/or uplink data signals based on the results of deciding whether or not retransmission control is necessary for the downlink control signals and/or downlink data signals, and so on.

The control section 401 also controls repetition transmission of UL data, by using TBs, in UL grant-free transmission. In this case, when UL data is transmitted by using a plurality of TBs, each TB is time-division-multiplexed, frequency-division-multiplexed, or code-division-multiplexed. That is, when the packet contains a plurality of TBs, the control section 401 frequency-division-multiplexes or code-division-multiplexes the plurality of TBs (see FIG. 4B) (the first example). That is, when the packet contains a plurality of TBs, the control section 401 time-division-multiplexes the plurality of TBs (see FIG. 5) (the second example).

Also, when there are multiple TBs, the control section 401 suspends the repetition transmission of a TB corresponding to UL data, and, after transmitting a TB corresponding to initial transmission of new data, resumes the repetition transmission of the already-transmitted TB, corresponding to UL data (see FIG. 6.) (the first option of the third example).

Also, the control section 401, the terminal reports a scheduling request for new data to the radio base station by using the control channel.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit or signal generating apparatus that can be described based on general understanding of the technical field to which the present invention pertains.

For example, the transmission signal generation section 402 generates uplink control signals related to delivery acknowledgement information and/or channel state information (CSI) based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 outputs the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. For example, the measurement section 405 performs measurements using downlink reference signals transmitted from the radio base station 10. The measurement section 405 can be constituted by a measurer, a measurement circuit or measurement apparatus that can be described based on general understanding of the technical field to which the present invention pertains.

The measurement section 405 may measure the received power (for example, RSRP), the received quality (for example, RSRQ, SINR, etc.), downlink transmission path information (for example, CSI), and so on. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire or wireless, for example) and using these multiple pieces of apparatus.

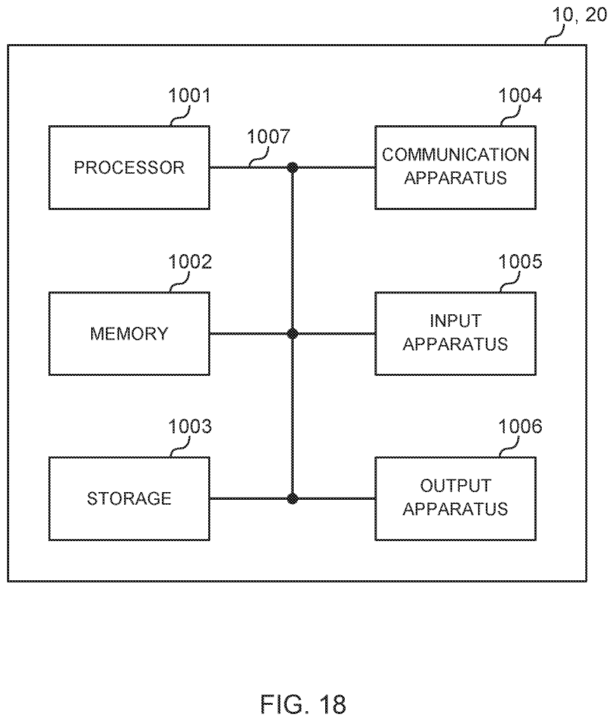

For example, the radio base station, terminals and so on according to one embodiment of the present invention may function as a computer that executes the processes of the radio communication method of the present invention. FIG. 18 is a diagram to show an example hardware structure of a radio base station and a terminal according to one embodiment of the present invention. Physically, the above-described radio base stations 10 and terminals 20 may be formed as a computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a terminal 20 may be designed to include one or more of each apparatus shown in the drawings, or may be designed not to include part of the apparatus.

For example, although only 1 processor 1001 is shown, a plurality of processors may be provided. Furthermore, processes may be implemented with 1 processor, or processes may be implemented in sequence, or in different manners, on one or more processors. Note that the processor 1001 may be implemented with one or more chips.

Each function of the radio base station 10 and the terminal 20 is implemented by reading predetermined software (program) on hardware such as the processor 1001 and the memory 1002, and by controlling the calculations in the processor 1001, the communication in the communication apparatus 1004, and the reading and/or writing of data in the memory 1002 and the storage 1003.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory” (primary storage apparatus) and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving apparatus) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals” (or “signaling”). Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. A subframe may be a fixed time duration (for example, 1 ms) not dependent on the numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a plurality of minislots. Each minislot may consist of one or more symbols in the time domain. Also, a minislot may be referred to as a “subslot.”

A radio frame, a subframe, a slot, a minislot and a symbol all represent the time unit in signal communication. A radio frame, a subframe, a slot, a minislot and a symbol may be each called by other applicable names. For example, 1 subframe may be referred to as a “transmission time interval (TTI),” or a plurality of consecutive subframes may be referred to as a “TTI,” or 1 slot or mini-slot may be referred to as a “TTI.” That is, a subframe and/or a TTI may be a subframe (1 ms) in existing LTE, may be a shorter period than 1 ms (for example, 1 to 13 symbols), or may be a longer period of time than 1 ms. Note that the unit to represent the TTI may be referred to as a “slot,” a “mini slot” and so on, instead of a “subframe.”

Here, a TTI refers to the minimum time unit of scheduling in radio communication, for example. For example, in LTE systems, a radio base station schedules the radio resources (such as the frequency bandwidth and transmission power that can be used in each terminal) to allocate to each terminal in TTI units. Note that the definition of TTIs is not limited to this.

The TTI may be the transmission time unit of channel-encoded data packets (transport blocks), code blocks and/or codewords, or may be the unit of processing in scheduling, link adaptation and so on. Note that, when a TTI is given, the period of time (for example, the number of symbols) in which transport blocks, code blocks and/or codewords are actually mapped may be shorter than the TTI.

Note that, when 1 slot or 1 minislot is referred to as a “TTI,” one or more TTIs (that is, one or multiple slots or one or more minislots) may be the minimum time unit of scheduling. Also, the number of slots (the number of minislots) to constitute this minimum time unit of scheduling may be controlled.

A TTI having a time length of 1 ms may be referred to as a “normal TTI (TTI in LTE Rel. 8 to 12),” a “long TTI,” a “normal subframe,” a “long subframe,” and so on. A TTI that is shorter than a normal TTI may be referred to as a “shortened TTI,” a “short TTI,” “a partial TTI (or a “fractional TTI”), a “shortened subframe,” a “short subframe,” a “mini-slot,” “a sub-slot” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be 1 slot, 1 minislot, 1 subframe or 1 TTI in length. 1 TTI and 1 subframe each may be comprised of one or more resource blocks. Note that one or more RBs may be referred to as a “physical resource block (PRB (Physical RB)),” a “subcarrier group (SCG),” a “resource element group (REG),” a “PRB pair,” an “RB pair” and so on.

Furthermore, a resource block may be comprised of one or more resource elements (REs). For example, 1 RE may be a radio resource field of 1 subcarrier and 1 symbol.

Note that the structures of radio frames, subframes, slots, minislots, symbols and so on described above are merely examples. For example, configurations pertaining to the number of subframes included in a radio frame, the number of slots included in a subframe, the number of mini-slots included in a slot, the number of symbols and RBs included in a slot or a mini-slot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to predetermined values, or may be represented in other equivalent information formats. For example, radio resources may be specified by predetermined indices. In addition, equations to use these parameters and so on may be used, apart from those explicitly disclosed in this specification.

The names used for parameters and so on in this specification are in no respect limiting. For example, since various channels (PUCCH (Physical Uplink Control Channel), PDCCH (Physical Downlink Control Channel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, a memory), or may be managed using a management table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent implicitly (by, for example, not reporting this piece of information or by reporting other pieces of information).

Decisions may be made in values represented by 1 bit (0 or 1), may be made in Boolean values that represent true or false, or may be made by comparing numerical values (for example, comparison against a predetermined value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, 3) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS)” “terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as terminals. For example, each aspect/embodiment of the present invention may be applied to a configuration in which communication between a radio base station and a terminal is replaced with communication among a plurality of terminals (D2D (Device-to-Device)). In this case, terminals 20 may have the functions of the radio base stations 10 described above. In addition, terms such as “uplink” and “downlink” may be interpreted as “side.” For example, an “uplink channel” may be interpreted as a “side channel.”

Likewise, the terminals in this specification may be interpreted as radio base stations. In this case, the radio base stations 10 may have the functions of the terminals 20 described above.

Certain actions which have been described in this specification to be performed by base stations may, in some cases, be performed by higher nodes (upper nodes). In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate radio communication methods, and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used only for convenience, as a method for distinguishing between two or more elements. In this way, reference to the first and second elements does not imply that only 2 elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.” As used herein, two elements may be considered “connected” or “coupled” to each other by using one or more electrical wires, cables and/or printed electrical connections, and, as a number of non-limiting and non-inclusive examples, by using electromagnetic energy, having wavelengths in the radio frequency, microwave and/or optical regions (both visible and invisible).

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A terminal comprising:
a transmission section that transmits UL data without a UL transmission command from a radio base station; and
a control section that controls repetition transmission of the UL data by using a transport block (TB),
wherein, when the UL data is transmitted using a plurality of TBs, the control section at least time-division-multiplexes, frequency-division-multiplexes or code-division-multiplexes each TB.

2. The terminal according to claim 1, wherein the control section suspends repetition transmission of a TB corresponding to UL data, and, after a TB corresponding to initial transmission of new UL data is transmitted, resumes the repetition transmission of the already-transmitted TB corresponding to UL data.

3. The terminal according to claim 1, wherein the control section reports a scheduling request for new data.

4. The terminal according to claim 1, further comprising a receiving section that receives at least one of information about the number of TBs used to transmit the UL data, information about configuration of repetition transmission of TBs, and information about TBs that are configured.

5. The terminal according to claim 1, wherein, when transmitting each TB, the transmission section transmits information that identifies each TB.

6. A radio communication method for a terminal, comprising the steps of:
transmitting UL data without a UL transmission command from a radio base station; and
controlling repetition transmission of the UL data by using a transport block (TB),
wherein, when the UL data is transmitted using a plurality of TBs, each TB is at least time-division-multiplexed, frequency-division-multiplexed or code-division-multiplexed.

7. The terminal according to claim 2, further comprising a receiving section that receives at least one of information about the number of TBs used to transmit the UL data, information about configuration of repetition transmission of TBs, and information about TBs that are configured.

8. The terminal according to claim 3, further comprising a receiving section that receives at least one of information about the number of TBs used to transmit the UL data, information about configuration of repetition transmission of TBs, and information about TBs that are configured.

9. The terminal according to claim 2, wherein, when transmitting each TB, the transmission section transmits information that identifies each TB.

10. The terminal according to claim 3, wherein, when transmitting each TB, the transmission section transmits information that identifies each TB.

11. The terminal according to claim 4, wherein, when transmitting each TB, the transmission section transmits information that identifies each TB.
